(19) United States
(12) Patent Application Publication
(10) Pub. No.: US 2011/0215097 A1
(43) Pub. Date: Sep. 8, 2011

(54) DUAL COMPARTMENT SANDWICH CONTAINER AND METHOD OF MAKING SAME

(76) Inventors: Willard Nelson Archie, JR., Hillsborough, CA (US); Christopher Loew, Palo Alto, CA (US); David Christophe Northway, San Carlos, CA (US)

(21) Appl. No.: 12/873,892

(22) Filed: Sep. 1, 2010

Related U.S. Application Data
(60) Provisional application No. 61/339,812, filed on Mar. 8, 2010.

(51) Int. Cl. B65D 21/02; B65D 25/04; B65D 43/16; B23P 19/04

(52) U.S. Cl. 220/23.83; 220/553; 220/833; 29/428

(57) ABSTRACT

A flexible divider for separating a lower compartment of a container from an upper compartment of the container includes a transverse member and a rim defining an outer perimeter of the divider. The flexible divider also includes a flexible wall connecting the transverse member to the rim. The flexible wall is configured to facilitate movement of the transverse member from an upper stable position to a lower stable position.

### CROSS REFERENCE TO RELATED APPLICATIONS

This application claims the priority of Provisional Patent Application Ser. No. 61/339,812, entitled “DUAL COMPARTMENT SANDWICH CONTAINER WITH A ROTATABLE FLEXIBLE BI-STABLE DIVIDER”, which was filed on Mar. 8, 2010 and which is hereby incorporated by reference in its entirety.

### BACKGROUND OF THE INVENTION

This invention relates generally to food storage containers, and specifically to a reusable sandwich container having multiple compartments for housing a plurality of food-related products.

Many workers have elected to bring their lunch from home in a bag or container rather than incur the cost and time associated with eating out. Also, many parents elect to prepare and send lunch to school with their children. Moreover, many people elect to attend picnics and other functions and further elect to bring their own meals. Many known food containers are large enough to be used to contain a sandwich for future consumption. However, because there is usually a long time delay between the preparation and consumption of a sandwich, many sandwiches prepared a period of time prior to consumption may become warm and soggy as the dry sandwich bread absorbs liquid from sandwich contents that include meats, condiments, and toppings such as tomatoes and/or lettuce. Such a sandwich may fall apart or become difficult to consume. Moreover, without refrigeration, over a period of time prior to consumption, the sandwich ingredients will approach ambient temperatures, thereby causing the sandwich to be less appealing. Further, the freshness of the ingredients may be compromised. If certain ingredients are compromised, the entire sandwich could become significantly comprised and possibly cause serious illness in the event of consumption by a user.

Compartmentalized food containers are known in the art. However, few conventional food containers are suitable to be reused and adequate for protecting a sandwich against being flattened as well as losing its freshness in a relatively short time, especially in warm weather. At least some of the known food containers are soft containers, for example, paper and plastic bags. Such containers provide little to no protection against physical damage to the enclosed sandwich. Also, many of the known food containers are single-use containers, thereby increasing waste stream traffic. Further, although some conventional food containers are known to provide temporary sandwich storage, no food container is known which includes a rotatable fluid-tight divider that is adapted to isolate the relatively dry bread from the relatively wet sandwich ingredients in separate compartments so as to prevent the bread from becoming soggy and inedible between the time that the sandwich container is initially packed and the time that the sandwich is ultimately consumed. More particularly, no sandwich container is known having a divider which can be manipulated to assume different configurations so that the storage capacities of different compartments of the container that are isolated by the divider can be selectively adjusted to carry therewithin either slices of dry bread and the wet ingredients for making a sandwich or a ready-to-eat sandwich where the ingredients are placed between the slices within a larger compartment size. Furthermore, no sandwich container is known having a hollow, removable tray to be located in one of the storage compartments wherein the tray is filled with a thermal gel of the kind to be refrigerated or frozen to create a cold pack to chill the sandwich ingredients and prevent spoilage prior to consumption.

### BRIEF DESCRIPTION OF THE INVENTION

In one aspect, a flexible divider for separating a lower compartment of a container from an upper compartment of the container is provided. The flexible divider includes a transverse member and a rim defining an outer perimeter of the divider. The flexible divider also includes a flexible wall connecting the transverse member to the rim. The flexible wall is configured to facilitate movement of the transverse member from an upper stable position to a lower stable position.

In another aspect, a sandwich container is provided. The sandwich container includes an outer housing defining a first compartment and a second compartment. The sandwich container also includes a divider separating the first and second compartments. The divider is reconfigurable for altering a volume of each of the first and the second compartments.

In yet another aspect, a method of assembling a sandwich container is provided. The method includes hingedly coupling an upper body to a lower body. The upper body defines an upper compartment and the lower body defines a lower compartment. The method also includes positioning a flexible divider within the sandwich container, thereby separating the upper and lower compartments. The flexible divider includes a transverse member and a rim defining an outer perimeter of the divider. The flexible divider also includes a flexible wall connecting the transverse member to the rim. The flexible wall is configured to facilitate movement of the transverse member from an upper stable position to a lower stable position.

### BRIEF DESCRIPTION OF THE DRAWINGS

FIG. 1 is a first exploded view of an exemplary dual compartment sandwich container having an adjustable divider.

FIG. 2 is a side view of a first alternative exemplary dual compartment sandwich container having a tongue and groove sealing mechanism.

FIG. 3 is a perspective view of the sandwich container shown in FIG. 2.

FIG. 4 is an exploded view of the sandwich container shown in FIGS. 2 and 3.

FIG. 5 is a schematic cross-sectional side view of a plurality of configurations of the sandwich container shown in FIGS. 2, 3, and 4.

FIG. 6 is a perspective partial cutaway view of a second alternative exemplary embodiment including an asymmetrical two-piece dual compartment sandwich container.

FIG. 7 is an exploded view of the sandwich container shown in FIG. 6.

FIG. 8 is a schematic cross-sectional side view of a plurality of configurations of the sandwich container shown in FIGS. 6 and 7.

FIG. 9 is a perspective view of a third alternative exemplary embodiment including a symmetrical one-piece hinged dual compartment sandwich container.

FIG. 10 is a exploded view of the sandwich container shown in FIG. 9.

FIG. 11 is a schematic cross-sectional side view of a plurality of configurations of the sandwich container shown in FIGS. 9 and 10.

FIG. 12 is a perspective view of an alternative exemplary configuration of the sandwich container shown in FIGS. 9, 10, and 11.

FIG. 13 is a perspective view of an alternative exemplary configuration of the sandwich container shown in FIG. 12.

FIG. 14 is a perspective view of an exemplary racked dual compartment sandwich container.

FIG. 15 is a side view of an alternative exemplary racked dual compartment sandwich container similar to that shown in FIG. 14.

FIG. 16 is an inside perspective view of the exemplary racked dual compartment sandwich containers shown in FIGS. 14 and 15.

FIG. 17 is a perspective view of a dual compartment sandwich container similar to that shown in FIG. 1, but with a first alternative closing mechanism.

FIG. 18 is a front view of the sandwich container shown in FIG. 17.

FIG. 19 is a perspective view of a dual compartment sandwich container similar to that shown in FIG. 1, but with a second alternative closing mechanism.

FIG. 20 is a perspective view of a dual compartment sandwich container similar to that shown in FIG. 1, but with a third alternative closing mechanism.

FIG. 21 is a perspective view of an alternative adjustable divider that may be used with the dual compartment sandwich container shown in FIGS. 1, 17, 18, 19, and 20.

FIG. 22 is a schematic cross-sectional side view of a wiping sealing mechanism that may be used with the adjustable divider shown in FIG. 21.

FIG. 23 is a schematic cross-sectional side view of a compression sealing mechanism that may be used with the adjustable divider shown in FIG. 21.

FIG. 24 is a schematic cross-sectional side view of the adjustable divider shown in FIG. 21 in a lower/recessed stable position.

FIG. 25 is a schematic cross-sectional side view of the adjustable divider shown in FIG. 21 in an upper/raised stable position.

FIG. 26 is a schematic cross-sectional side view of the dual compartment sandwich container shown in FIG. 1 with the alternative adjustable divider shown in FIG. 21 in the upper/raised stable position as shown in FIG. 25 with a removable tray therein.

### DETAILED DESCRIPTION OF THE INVENTION

The following detailed description illustrates the disclosure by way of example and not by way of limitation. The description clearly enables one skilled in the art to make and use the disclosure, describes several embodiments, adaptations, variations, alternatives, and use of the disclosure, including what is presently believed to be the best mode of carrying out the disclosure.

The effectiveness of a sandwich container can be measured by the temperature and freshness of its sandwich ingredients and the dryness of the bread. The effectiveness of a sandwich container can also be measured by how well it protects the sandwich and/or sandwich ingredients from crushing during transport and storage. Therefore, to be effective, a sandwich storage container should have sufficient strength to reduce a potential for damage to the sandwich. Also, the sandwich storage container should have sufficient strength to withstand repeated use, including repeated washings and openings/closings. Moreover, the sandwich container should provide sufficient internal storage space to either separate the bread slices from the wet ingredients and/or incorporate a mechanism to keep the sandwich ingredients cool and fresh. Furthermore, the sandwich container should facilitate ease of cleaning after each use and then be reused so as to reduce waste.

The sandwich containers described herein, and the methods of assembling such sandwich containers, facilitate storage and transport of sandwiches and sandwich materials. Specifically, the sandwich containers are assembled to maintain a freshness and/or a temperature of a completed sandwich, or the ingredients therein. Also, specifically, the sandwich containers are assembled to maintain the bread in a dry state. More specifically, the sandwich containers described herein provide sufficient internal storage space to either separate the bread slices from the wet ingredients and/or a mechanism to keep the sandwich ingredients cool and fresh. Further, specifically, the sandwich containers are assembled to protect the sandwich and/or sandwich ingredients from crushing during transport and storage. Therefore, the sandwich storage containers described herein have sufficient strength to reduce a potential for damage to the sandwich and to withstand repeated use, including repeated washings. Moreover, the sandwich containers described herein include components that facilitate ease of converting the sandwich containers from storage for sandwich components to storage for ready-to-eat sandwiches with only minor adjustments of the configuration of the sandwich containers. Furthermore, the sandwich containers described herein facilitate ease of cleaning after each use and are then to be reused so as to reduce waste. In alternative embodiments, materials may be used that facilitate fabricating a disposable sandwich container with at least some of the features of the sandwich containers described herein.

Moreover, the containers described herein are substantially sized and configured for sandwiches for exemplary purposes only and are not intended to limit the use of such containers to merely sandwiches. Therefore, the containers described herein are not limited to sandwiches and can be used to house any food product.

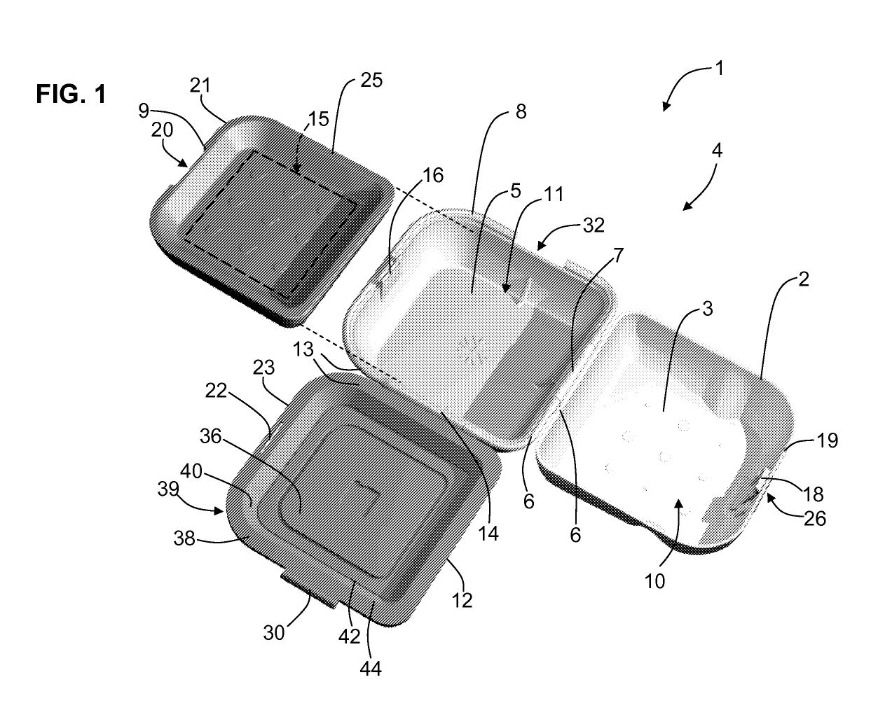

FIG. 1 is a first exploded view of an exemplary dual compartment sandwich container 1 having an adjustable divider 12. In the exemplary embodiment, dual compartment sandwich container 1 includes an outer housing 4 that includes an upper compartment body 3 and a lower compartment body 5, wherein both bodies 3 and 5 are hingedly coupled to each other along respective and opposing rear edges 6 by a hinge 7 extending therebetween. Upper compartment body 3, hereon referred to as upper body 3, defines an upper compartment 10 and lower compartment body 5, hereon referred to as lower body 5, defines a lower compartment 11. Also, in the exemplary embodiment, lower compartment 11 may receive a removable tray 9. Upper body 3 and lower body 5 define a clam-shell-shaped configuration of container 1. Upper compartment 10 is sometimes referred to as the lid or top compartment. Lower compartment 11 is sometimes referred to as a tray or bottom compartment. Upper body 3 includes a rim 2 that defines a perimeter extending around an outer edge of upper compartment 10. Also, lower body 5 includes a rim 8 that defines a perimeter extending around an outer edge of lower compartment 11.

Further, in the exemplary embodiment, removable tray 9 defines a cavity therein (not shown in FIG. 1) in which a thermal gel 15 is stored. Thermal gel 15 is substantially similar to that found in a commercially-available cold pack and is adapted to maintain a low temperature (i.e., a temperature below a predefined temperature) for an extended period of time after first being refrigerated or frozen. Moreover, thermal gel 15 may also be adaptable to maintain an elevated temperature (i.e., a temperature above a predefined temperature) after first being heated. Therefore, thermal gel 15 inside removable tray 9 facilitates maintaining the sandwich ingredients approximately at a desired temperature to reduce a potential for spoilage when the sandwich will not be immediately consumed. As described below, the storage capacity of upper compartment 10 may be selectively adjusted to hold either two slices of bread or a complete sandwich (neither shown in FIG. 1).

In the exemplary embodiment, sandwich container 1 is substantially formed of durable plastic and/or rubber compounds having a size and shape that facilitate receipt and transport of two slices of dry bread and wet ingredients for making a typical sandwich. Alternatively, sandwich container 1 is formed of any materials that enable operation of sandwich container 1 as described herein. Such materials facilitate durability of container 1, reduce a potential of damage to ingredients placed therein during handling and transport of container 1, and are washable and reusable.

Also, in at least one embodiment, removable tray 9 is formed such that air gaps (not shown) may be formed in the vicinity of the perimeter and/or the lower surface of removable tray 9 to further provide at least some insulating features to reduce a potential for formation of condensation within, and on the exterior of, sandwich container 1. Accordingly, removable tray 9 is configured to reduce a potential for introduction of liquids to any dry bread slices (not shown in FIG. 1) that may be introduced into sandwich container 1.

Further, in the exemplary embodiment, dual compartment sandwich container 1 includes an adjustable divider 12, that is, specifically, a rotatable, flexible bi-stable divider 12 located between upper and lower compartments 10 and 11, respectively. In the exemplary embodiment, and as discussed further below, divider 12 is sized to be complementary to removable tray 9. Divider 12 is manufactured from silicone rubber, thermoplastic elastomer (TPE) or any suitable elastomeric material that enables operation of sandwich container 1 as described herein. Moreover, divider 12 is manufactured from any materials that enable operation of sandwich container 1 as described herein.

Divider 12 has flexibility characteristics that facilitate selectively changing divider 12 to one of two stable configurations, each described further below, as a function of the contents to be carried within upper and lower compartments 10 and 11, respectively, as discussed further below. Alternatively, divider 12 is manufactured from any material that enables operation of sandwich container 1 including, without limitation, hard plastics. Adjustable divider 12 is hingedly coupled to lower body 5 along respective and opposing edges 13 of lower body 5 and divider 12 by a hinge 14. Divider 12 is adapted to rotate at hinge 14 between an unseated or raised position lying outside lower body 5 and a seated position lying overtop lower compartment 11 and removable tray 9 located therein. Therefore, the dry slices of bread carried in upper compartment 10 and any wet sandwich ingredients in lower compartment 11 are segregated from one another to significantly reduce a potential of migration of liquids and moisture therebetween.

Dual compartment sandwich container 1 also includes a hard plastic locking tang 16 that extends upwardly from a front of lower body 5 opposite hinge 7. An open window (not shown) is defined within locking tang 16. Sandwich container 1 further includes a flexible locking clasp 18 located inside upper compartment 10 at a front portion 19 thereof and opposite hinge 7. Also, removable tray 9 includes a rim 25 that defines a notch 20 at a front portion 21 of removable tray 9. Divider 12 defines a locking slot 22 within a front portion 23 of divider 12.

In the assembled and closed sandwich container configuration, tray 9 is removably received within lower compartment 11 and divider 12 is rotated at hinge 14 from its unseated position to its seated position in order to cover tray 9 and thereby form a substantially air and moisture-tight barrier to isolate upper and lower compartments 10 and 11, respectively, from each another. Moreover, upper body 3 is rotated at hinge 7 towards lower body 5 to extend over divider 12. Locking slot 22 of divider 12 is substantially aligned with locking tang 16, extending from lower body 5. As upper body 3 is rotated over divider 12, flexible locking clasp 18 of upper body 3 will first be bent by hard plastic locking tang 16 to store energy and then snap into detachable locking engagement with locking tang 16 at the open window formed therein. That is, flexible locking clasp 18 has a spring memory that induces clasp 18 to release stored energy such that it snaps into, and maintains detachable locking engagement with, locking tang 16 whenever sandwich container 1 is fully closed. While locking clasp 18 engages locking tang 16, sandwich container 1 will be held in the closed (and locked) configuration to prevent upper body 3 from inadvertently rotating off and away from lower body 5.

Dual compartment sandwich container 1 further includes an integral push button 26 formed at an exterior portion of front portion 19 of upper body 3 and is operatively coupled to locking clasp 18. Push button 26 is preferably manufactured from a resilient material which may be momentarily compressed, such that a manual pushing force applied thereto is transmitted to locking clasp 18. Push button 26 is configured to disengage locking clasp 18 from locking tang 16. Flexible locking clasp 18 is correspondingly pushed away from and out of its locking engagement with locking tang 16 of lower body 5. Sandwich container 1 may now be opened to gain access to the interior thereof and to the sandwich bread and ingredients. When the pushing force is removed therefrom, the initial pre-compression shape of push button 26 is substantially automatically restored.

Dual compartment sandwich container 1 also includes a lifting lip 30 integrally formed with divider 12, wherein lifting lip 30 extends from divider 12 opposite hinge 14. A lifting slot 32 is formed in lower body 5 opposite hinge 14, wherein slot 32 receives lifting lip 30 when divider 12 is closed upon lower body 5. Specifically, when divider 12 is rotated at hinge 14 towards lower body 5 to its seated position covering tray 9, lifting lip 30 will be removably received within lifting slot 32. Thus, lifting lip 30 will be conveniently accessible to receive a lifting force applied thereto when it is desirable to rotate divider 12 away from lower body 5 and towards its unseated position.

Divider 12 includes a plurality of segments that are each coupled together at an associated hinge mechanism. Specifically, the plurality of segments of divider 12 include a flat traverse member, or base 36, a peripheral inner lip, or inner rim 38, a peripheral outer lip, or outer rim 39 opposite to rim 38, and a sloping intermediate wall 40 extending between base 36 and rim 38. Divider inner rim 38 and outer rim 39 define a perimeter extending around an outer edge of divider rims 38 and 39. Regardless of the disposition of removable tray 9, that is, inserted or not inserted within sandwich container 1, when divider 12 is moved to a closed position, divider inner rim 38 contacts lower body rim 8 and forms a seal thereon.

Moreover, divider 12 includes a first and a second hinge mechanism, that is, a first and a second thin reversing crease 42 and 44, respectively. Reversing creases 42 and 44 are configured and positioned such that the segments, that is, base 36, rim 38, and wall 40 can be displaced relative to one another, whereby divider 12 can be manipulated by the user to either one of a stable upper, or raised cap position/configuration, or a stable lower, or recessed dish position/configuration in response to a pressing force applied thereto. More specifically, reversing creases 42 and 44 are portions of divider 12 that are made of substantially similar materials as adjoining portions of divider 12, however, reversing creases 42 and 44 are thinner than such adjoining portions, thereby at least partially weakening those portions of divider 12 defined by reversing creases 42 and 44. Also, specifically, flat base 36 is hingedly coupled to intermediate wall 40 by reversing crease 42 therebetween and intermediate wall 40 is hingedly coupled to peripheral rim 38 by reversing crease 44 therebetween. Therefore, in the exemplary embodiment, a storage capacity of lower compartment 11 can be selectively adjusted to receive removable tray 9 with or without the wet ingredients for making a sandwich lying therein. Moreover, adjustable divider 12 facilitates forming a substantially air and moisture-tight barrier between upper and lower compartments 10 and 11, respectively. In the exemplary embodiment, divider 12 includes two reversing creases. Alternatively, divider 12 includes any number of reversing creases that enable operation of divider 12 as described herein.

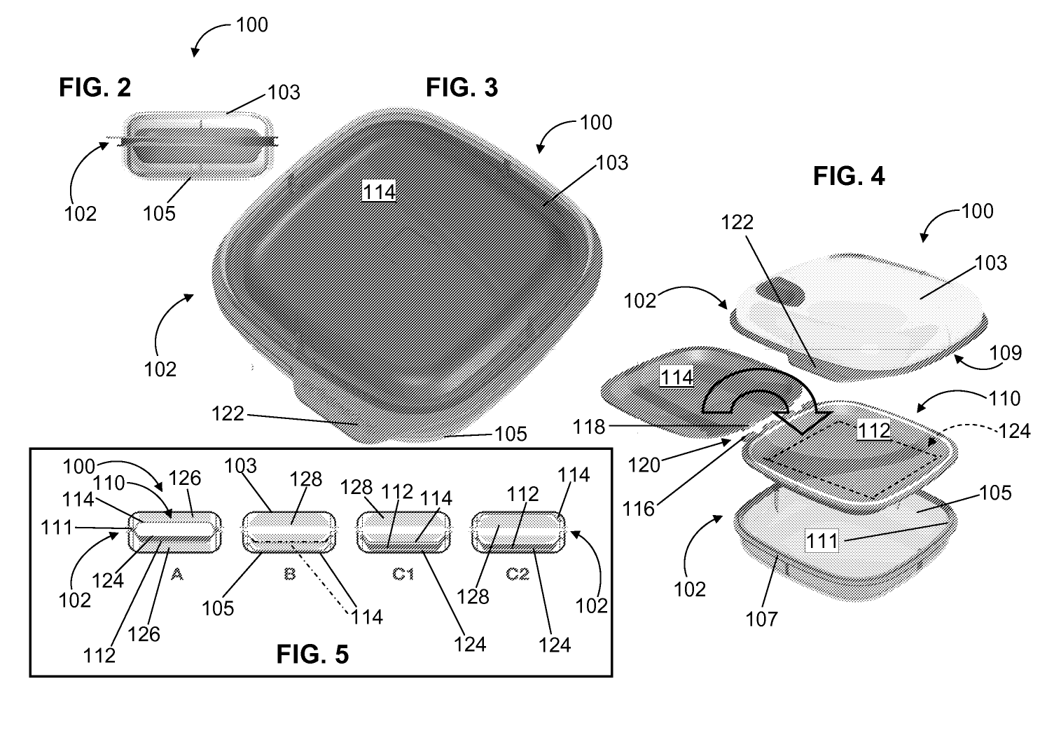

FIG. 2 is a side view of a first alternative exemplary dual compartment sandwich container 100 having a tongue and groove sealing mechanism 102. FIG. 3 is a perspective view of sandwich container 100. FIG. 4 is an exploded view of sandwich container 100. FIG. 5 is a schematic cross-sectional side view of a plurality of configurations A, B, C1, and C2 of sandwich container 100.

Sandwich container 100 includes an upper body 103 and a lower body 105 that are coupled to one another along a respective tongue 107 that extends along an outermost edge of lower body 105 and a groove 109 that extends along an outermost edge of upper body 103, thereby forming a tongue and groove sealing mechanism 102.

Upper body 103 and lower body 105 define a clam-shell-shaped container 100. Upper body 103 is sometimes referred to as the lid or top body. Lower body 105 is sometimes referred to as a tray or bottom body.

Sandwich container 100 also includes a removable tray 110. Tray 110 includes a lower tray 112 that is removably and hingedly coupled to a tray lid 114. Specifically, lower tray 112 includes a plurality of first hinges 116 and tray lid 114 includes a plurality of second hinges 118 that interlock with first hinges 116 to form a hinge mechanism 120 when lid 114 is coupled to tray 112. Moreover, when first hinges 116 and second hinges 118 are interlocked together, tray 112 and lid 114 form a clam-shell configuration that may be at least partially supported by an inner lip 111 of lower body 105. Lid 114 may also be uncoupled from tray 112 and inverted and nested within tray 112 such that both lid 114 and tray 112 form a double-tray configuration that is received within lower body 105.

Upper body 103 includes a lifting lip 122 that projects outwardly from upper body 103, wherein lifting lip 122 may be positioned on any side of upper body 103.

Lower tray 112 includes an upper surface, a lower surface, and a gel 124 positioned between the upper and lower surfaces. In an alternative embodiment, gel 124 is integral with tray 112 and/or lid 114. Gel 124 is substantially similar to that found in a commercially-available cold pack and is adapted to maintain a low temperature (i.e., a temperature below a predefined temperature) for an extended period of time after first being refrigerated or frozen. Moreover, gel 124 can be adaptable to also maintain an elevated temperature (i.e., a temperature above a predefined temperature) after first being heated.

Also, in at least one embodiment, lower tray 112 is formed such that air gaps (not shown) may be formed in the vicinity of the upper surface and/or the lower surface of lower tray 112 to further provide at least some insulating features to reduce a potential for formation of condensation within, and on the exterior of, sandwich container 100. Accordingly, lower tray 112 is configured to reduce a potential for introduction of liquids to any dry bread slices that may be introduced into sandwich container 100.

In the exemplary embodiment, sandwich container 100 is substantially formed of durable plastic and/or rubber compounds. Alternatively, sandwich container 100 is formed of any materials that enable operation of sandwich container 100 as described herein.

Configuration A in FIG. 5 shows tray mechanism 110 with tray lid 114 hingedly coupled to tray 112 and received within sandwich container 100 such that tray mechanism 110 is supported by inner lip 111 of lower compartment 105. Also, tongue and groove sealing mechanism 102 is sealingly engaged. Bread slices 126 are separated by tray mechanism 110 into upper compartment 103 and lower compartment 105 with wet ingredients (not shown) stored within tray mechanism 110. Tray 112, which is filled with gel 124, is refrigerated or frozen to create a cold pack, and receives and chills the wet ingredients for making a sandwich.

Configuration B in FIG. 5 shows tray mechanism 110 disassembled such that tray lid 114 is inverted (i.e., flipped over), rotated in a horizontal plane, and received within lower compartment 105 such that tray lid 114 is at least partially recessed within lower compartment 105. Tray lid 114 is adjustable within lower compartment 105 to vary a height of compartment 105. Also, tongue and groove sealing mechanism 102 is sealingly engaged. Tray 112 is not used in configuration B because no gel 124 is needed to maintain a desired temperature. A ready-to-eat sandwich 128 is received within sandwich container 100 and sits on tray lid 114, wherein the height of tray lid 114 may be varied as use dictates. Tray mechanism 110 may be removed in its entirety to facilitate receipt of a large sandwich 128.

Configuration C1 in FIG. 5 shows tray mechanism 110 disassembled such that tray lid 114 is inverted (i.e., flipped over), rotated in a horizontal plane, and received within tray 112, wherein both tray 112 and tray lid 114 are rotated in a horizontal plane and received and recessed within lower compartment 105. Ready-to-eat sandwich 128 is received within sandwich container 100 and sits on tray lid 114. Also, tray 112, which is filled with gel 124, is refrigerated or frozen to create a cold pack, and receives and chills sandwich 128 such that the sandwich ingredients are maintained cold and fresh to avoid spoilage when sandwich 128 will not be immediately consumed. Tray mechanism 110 may be removed in its entirety to facilitate receipt of a large sandwich 128.

Configuration C2 in FIG. 5 shows tray mechanism 110 disassembled such that tray lid 114 is removed from tray 112, tray 112 is received and recessed within lower compartment 105 and tray lid 114 is either removed entirely or is received and recessed within upper compartment 103. Ready-to-eat sandwich 128 is received on top of tray 112, that is, sandwich 128 sits on tray 112. Also, tray 112, which is filled with gel 124 and can be heated to an elevated temperature to create a hot pack, receives and heats the sandwich 128 such that the sandwich ingredients are maintained warm when sandwich 128 will not be immediately consumed. Tray mechanism 110 may be removed in its entirety to facilitate receipt of a large sandwich 128.

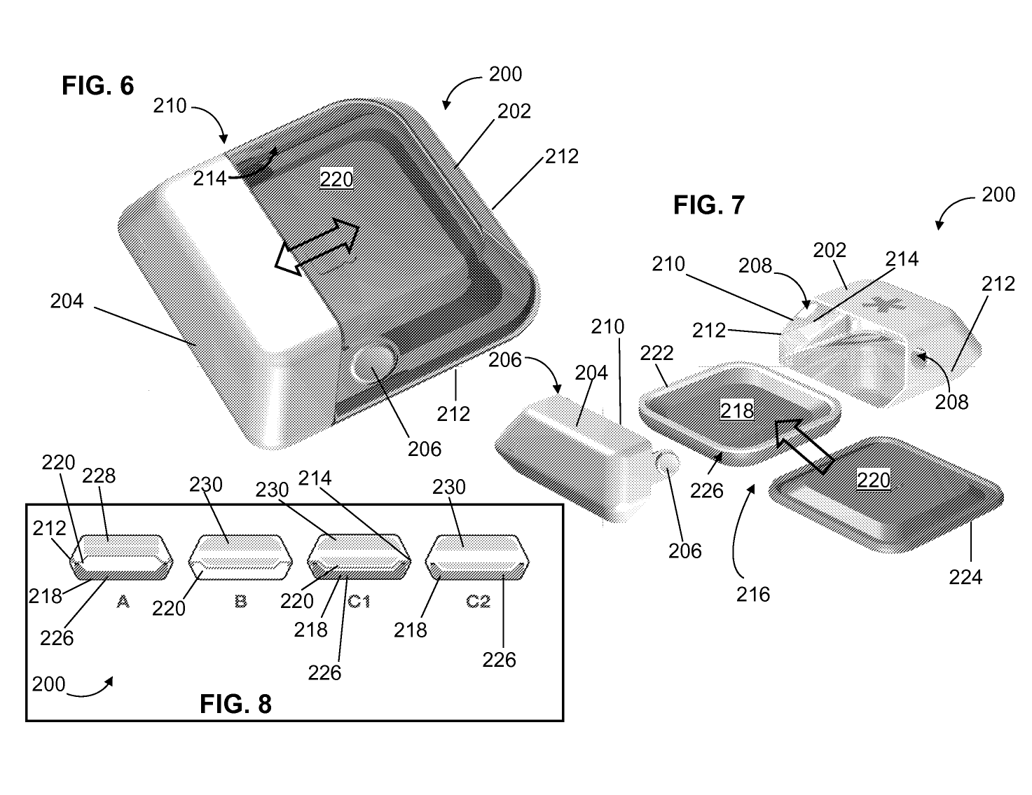

FIG. 6 is a perspective partial cutaway view of a second alternative embodiment including an asymmetrical two-piece dual compartment sandwich container 200. FIG. 7 is an exploded view of sandwich container 200. FIG. 8 is a schematic cross-sectional side view of a plurality of configurations A, B, C1, and C2 of sandwich container 200.

Sandwich container 200 includes a compartment piece 202 and a removable door piece 204. Door piece 204 is sometimes referred to as the garage door piece. Compartment piece 202 is sometimes referred to as the garage piece. Door piece 204 includes a plurality of pushbutton mechanisms 206 and compartment piece 202 includes a plurality of pushbutton access ports 208, wherein pushbutton mechanisms 206 and ports 208 engage to facilitate closing and sealing sandwich container 200. Mechanisms 206 are depressed to facilitate clearing ports 208 and separating pieces 202 and 204.

Both pieces 202 and 204 include edge sealing mechanisms 210 that are any sealing devices that enable operation of sandwich container 200 as described herein including, but not limited to, thermal sealing strips and/or substantially vapor-tight strips.

Compartment piece 202 defines a plurality of external side extensions 212 that extend along all three sides of piece 202 and define a support channel 214 within piece 202 on all three sides.

Sandwich container 200 also includes a removable tray mechanism 216 that is at least partially supported by support channels 214. Alternatively, sandwich container 200 does not include support channels 214, wherein tray mechanism 216 is supported within sandwich container 200 by any method that facilitates such support. Tray mechanism 216 includes a lower tray 218 that may be removably coupled to a tray lid 220. Specifically, lower tray 218 includes a top rim 222 and tray lid 220 includes a bottom rim 224, wherein bottom rim 224 receives top rim 222 to seal tray mechanism 216. Moreover, when tray mechanism 216 is sealed, it forms a closed configuration that may be at least partially supported by support channels 214. Lid 220 may also be uncoupled from tray 218 and inverted and nested within tray 218 such that both lid 220 and tray 218 forms a double-tray configuration that is at least partially received within support channels 214.

Lower tray 218 includes an upper surface, a lower surface, and a gel 226 positioned between the upper and lower surfaces (not shown). In an alternative embodiment, gel 226 is integral with tray 218 and/or lid 220. Gel 226 is substantially similar to that found in a commercially-available cold pack and is adapted to maintain a low temperature (i.e., a temperature below a predefined temperature) for an extended period of time after first being refrigerated or frozen. Moreover, gel 226 can be adaptable to maintain an elevated temperature (i.e., a temperature above a predefined temperature) after first being heated.

In at least one embodiment, tray 218 is formed such that air gaps (not shown) may be formed in the vicinity of the upper surface and/or the lower surface of tray 218 to further provide at least some insulating features to reduce a potential for formation of condensation within, and on the exterior of, sandwich container 200. Accordingly, tray 218 is configured to reduce a potential for introduction of liquids to any dry bread slices that may be introduced into sandwich container 200.

In the exemplary embodiment, sandwich container 200 is substantially formed of durable opaque plastic and/or rubber compounds. Alternatively, sandwich container 200 is formed of any materials that enable operation of sandwich container 200 as described herein including, but not limited to, metal and clear plastics.

Configuration A in FIG. 8 shows tray mechanism 216 with tray lid 220 coupled to tray 218 and received within sandwich container 200 such that tray mechanism 216 is supported by support channels 214 of compartment piece 202. Bread slices 228 are supported by tray mechanism 216 on top of tray lid 220 with wet ingredients (not shown) stored within tray mechanism 216 by being placed on top of tray 218. Tray 218, which is filled with gel 226, is refrigerated or frozen to create a cold pack, and receives and chills the wet ingredients for making a sandwich.

Configuration B in FIG. 8 shows tray mechanism 216 disassembled such that tray lid 220 is inverted (i.e., flipped over), rotated in a horizontal plane, and received within compartment piece 202 such that tray lid 220 is at least partially recessed within compartment piece 202. Tray 220 is supported by channels 214 of compartment piece 202. Tray 218 is not used in configuration B because no gel 226 is needed to maintain a desired temperature. A ready-to-eat sandwich 230 is received within sandwich container 200 and sits on tray lid 220. Tray mechanism 216 may be removed in its entirety to facilitate receipt of a large sandwich 230.

Configuration C1 in FIG. 8 shows tray mechanism 216 disassembled such that tray lid 220 is inverted and received within tray 218, wherein both tray 218 and tray lid 220 are received and recessed within compartment piece 202. Ready-to-eat sandwich 230 is received within sandwich container 200 and sits on tray lid 220. Also, tray 218, which is filled with gel 226, is refrigerated or frozen to create a cold pack, and receives and chills sandwich 230 such that the sandwich ingredients are maintained cold and fresh to avoid spoilage when sandwich 230 will not be immediately consumed. Also, tray 218, filled with gel 226, may be heated to an elevated temperature to create a hot pack, wherein tray 218 receives and heats the sandwich 230 such that the sandwich ingredients are maintained warm when sandwich 230 will not be immediately consumed. Tray mechanism 216 may be removed in its entirety to facilitate receipt of a large sandwich 230.

Configuration C2 in FIG. 8 shows tray mechanism 216 disassembled such that tray lid 220 is removed from tray mechanism 216, and tray 218 is received and recessed within compartment piece 202. Ready-to-eat sandwich 230 is received within sandwich container 200, that is, sandwich 230 sits on tray 218. Also, tray 218, which is filled with gel 226 may be heated to an elevated temperature to create a hot pack, receives and heats the sandwich 230 such that the sandwich ingredients are maintained warm when sandwich 230 will not be immediately consumed. Also, tray 218, filled with gel 226, may be refrigerated or frozen to create a cold pack, wherein tray 218 receives and chills sandwich 230 such that the sandwich ingredients are maintained cold and fresh to avoid spoilage when sandwich 230 will not be immediately consumed. Tray mechanism 216 may be removed in its entirety to facilitate receipt of a large sandwich 230.

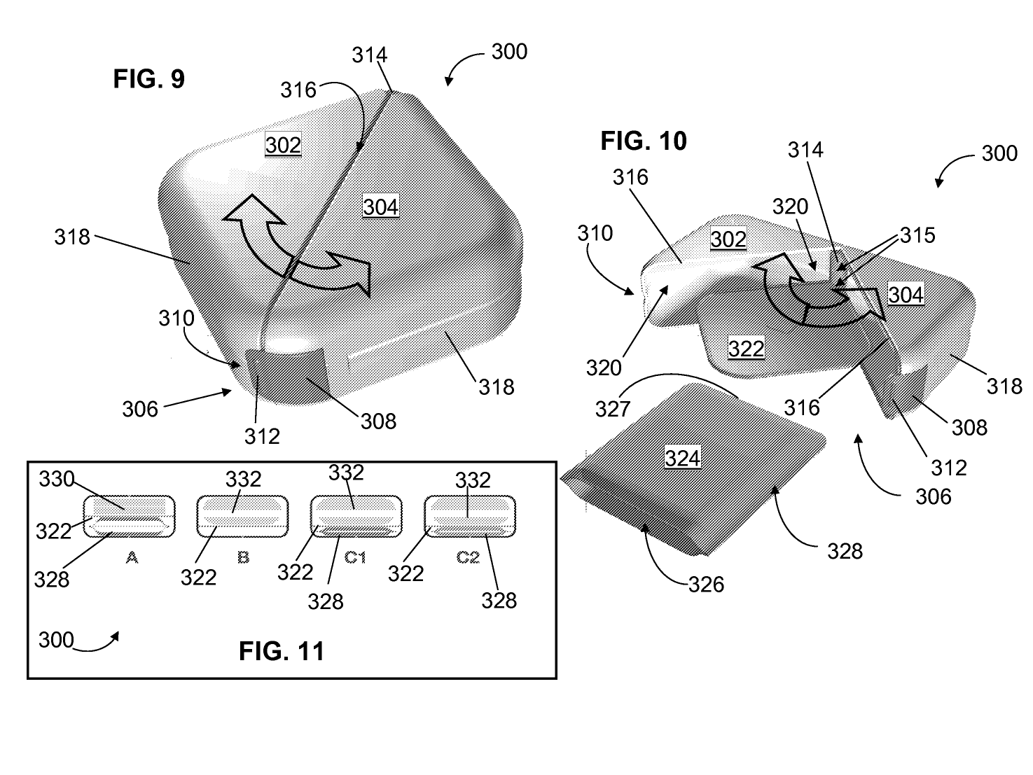

FIG. 9 is a perspective view of a third alternative embodiment including a symmetrical one-piece hinged dual compartment sandwich container 300. FIG. 10 is an exploded view of sandwich container 300. FIG. 11 is a schematic cross-sectional side view of a plurality of configurations A, B, C1, and C2 of sandwich container 300.

Sandwich container 300 includes a left-hand side (LHS) compartment piece 302 and a right-hand side (RHS) compartment piece 304. Sandwich container 300 also includes a latching device 306, wherein device 306 includes a latch clasp 308 coupled to RHS piece 304 and a latch groove 310 defined in LHS piece 302. Latch clasp 308 engages latch groove 310 to facilitate closing and sealing sandwich container 300. Latch clasp 308 includes an opening lip 312 to facilitate opening and closing of latching device 306.

Sandwich container 300 further includes a hinge post 314, wherein LHS piece 302 and RHS piece 304 are hingedly coupled to hinge post 314 at one corner of container 300 to facilitate an approximately 90° arcual movement in a plane orthogonal to hinge post 314. At a 0° angle, container 300 is substantially fully closed. At a 90° angle, container 300 is substantially fully open. Hinge post 314 defines a plurality of tray slots 315.

Both pieces 302 and 304 include edge sealing mechanisms 316 that are any sealing devices that enable operation of sandwich container 300 as described herein including, but not limited to, thermal sealing strips and/or substantially vapor-tight strips.

Both LHS piece 302 and RHS piece 304 define an external side protrusion 318 that extends along at least a portion of two sides of each of pieces 302 and 304 and define a support channel 320 within two sides of each of pieces 302 and 304.

Sandwich container 300 also includes an adjustable, removable tray 322 that is at least partially supported by one of tray slots 315 and support channels 320.

Sandwich container 300 also includes a sealable pouch 324, wherein pouch 324 includes a closeable end 326 and an opposite permanently sealed end 327. Pouch 324 is manufactured with a double-wall configuration such that a gel 328 is stored therein. Gel 328 is substantially similar to that found in a commercially-available cold pack and is adapted to maintain a low temperature (i.e., a temperature below a predefined temperature) for an extended period of time after first being refrigerated or frozen. Moreover, gel 328 is adaptable to maintain an elevated temperature (i.e., a temperature above a predefined temperature) after first being heated. Wet foods are enclosed within sealable pouch 324

In the exemplary embodiment, sandwich container 300 is substantially formed of aluminum. Alternatively, sandwich container 300 is formed of any materials that enable operation of sandwich container 300 as described herein including, but not limited to, durable plastics and/or rubber compounds.

Configuration A in FIG. 11 shows tray 322 received within sandwich container 300 such that adjustable tray 322 is supported by support channels 320 and one of tray slots 315. Bread slices 330 are supported by tray 322 on top of tray 322. Wet ingredients (not shown) are stored within pouch 324 that is received in the bottom of sandwich container 300 below tray 322. Pouch 324, which is filled with gel 328, is refrigerated or frozen to create a cold pack, and receives and chills the wet ingredients for making a sandwich. A potential for bread 328 to be exposed to condensation is reduced by adjusting a height of tray 322.

Configuration B in FIG. 11 shows adjustable tray 322 supported by support channels 320 and one of tray slots 315 with pouch 324 removed. A ready-to-eat sandwich 332 is received within sandwich container 300 and sits on tray 322.

Configuration C1 in FIG. 11 shows adjustable tray 322 supported by support channels 320 and one of tray slots 315. Pouch 324 is received in the bottom of sandwich container 300 below tray 322. Ready-to-eat sandwich 332 is received within sandwich container 300 and sits on top of adjustable tray 322. Also, pouch 324, which is filled with gel 328, is refrigerated or frozen to create a cold pack, and receives and chills sandwich 332 such that the sandwich ingredients are maintained cold and fresh to avoid spoilage when sandwich 332 will not be immediately consumed. Also, pouch 324, filled with gel 328, may heated to an elevated temperature to create a hot pack such that the sandwich ingredients are maintained warm when sandwich 332 will not be immediately consumed.

Configuration C2 in FIG. 11 shows adjustable tray 322 supported by support channels 320 and one of tray slots 315. Pouch 324 is received in the bottom of sandwich container 300 below tray 322. Ready-to-eat sandwich 332 is received within sandwich container 300 and sits on adjustable tray 322. Also, pouch 324, which is filled with gel 328, is heated to an elevated temperature to create a hot pack, receives and heats the sandwich 332 such that the sandwich ingredients are maintained warm when sandwich 332 will not be immediately consumed. Also, tray 322, filled with gel 328, may be refrigerated or frozen to create a cold pack, wherein tray 322 receives and chills sandwich 332 such that the sandwich ingredients are maintained cold and fresh to avoid spoilage when sandwich 332 will not be immediately consumed.

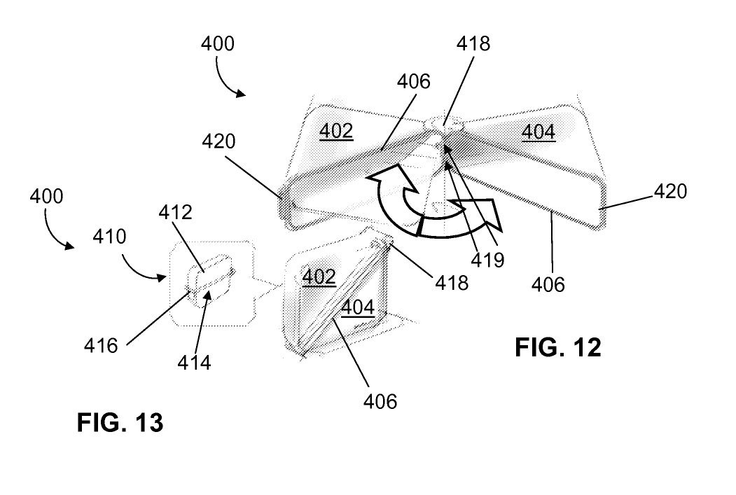

FIG. 12 is a perspective view of an alternative exemplary configuration 400 of sandwich container 300 shown in FIGS. 9, 10, and 11. FIG. 13 is a perspective view of an alternative exemplary configuration 410 of sandwich container 400 shown in FIG. 12. Configuration 400 includes a left-hand side (LHS) compartment piece 402 and a right-hand side (RHS) compartment piece 404. Pieces 402 and 404 define a diagonal sealing mechanism 406. Alternative configuration 410 includes an upper compartment piece 412 and a lower compartment piece 414. Pieces 412 and 414 define a horizontal sealing mechanism 416.

Configuration 400 also includes a hinge mechanism 418, wherein LHS piece 402 and RHS piece 404 are hingedly coupled to hinge mechanism 418 at one corner of configuration 400 to facilitate an approximately 90° arcual movement in a plane orthogonal to hinge mechanism 418. Hinge mechanism 418 defines a plurality of tray slots 419 that are configured to receive tray 322 (shown in FIGS. 10 and 11).

Configuration 400 further includes a latching device 420, wherein device 420 is any device that enables operation of configuration 400 as described herein.

In the exemplary embodiment, configuration 400 is substantially formed of aluminum. Alternatively, configuration 400 is formed of any materials that enable operation of configuration 400 as described herein including, but not limited to, durable plastics and/or rubber compounds.

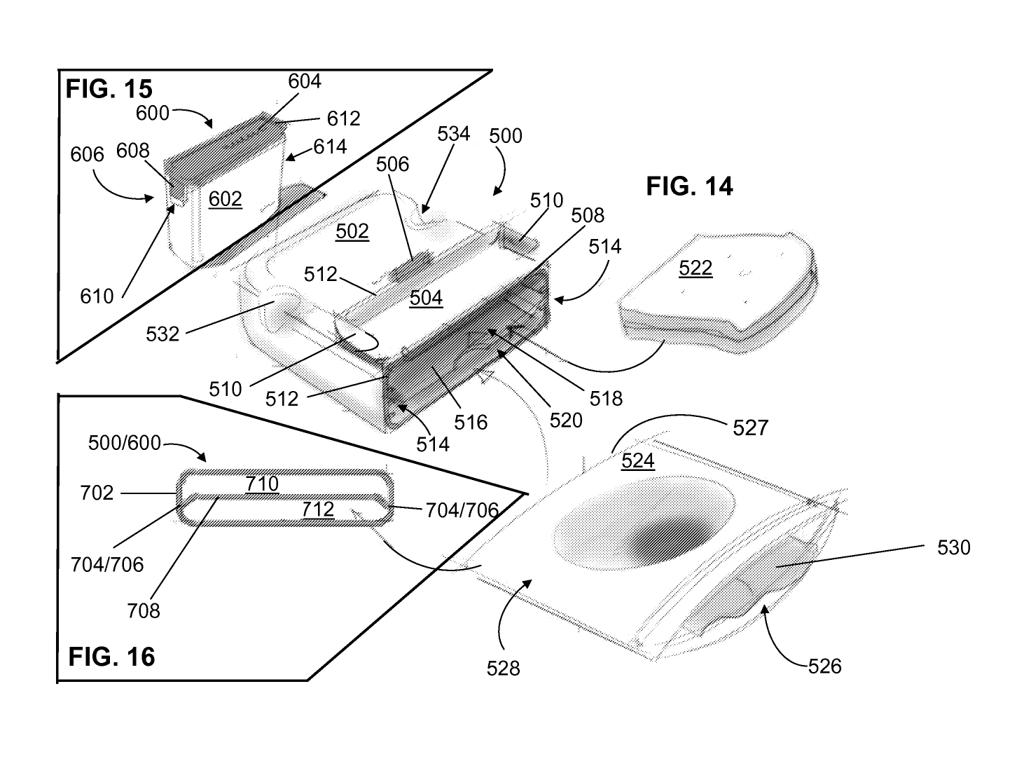

FIG. 14 is a perspective view of an exemplary racked dual compartment sandwich container 500. Sandwich container 500 includes a compartment piece 502 and a hingedly movable door piece 504. Door piece 504 includes a lifting lip 506 that engages a portion of compartment piece 502. Door piece 504 also includes a door hinge mechanism 508 that is hingedly coupled to both compartment piece 502 and door piece 504 at one edge of container 500 to facilitate an approximately 180° arcual movement in a plane orthogonal to hinge mechanism 508. Door piece 504 further includes a plurality of door ears 510. Lifting lip 506, door hinge mechanism 508, and door ears 510 facilitate opening, closing, and sealing sandwich container 500.

Both pieces 502 and 504 include edge sealing mechanisms 512 that are any sealing devices that enable operation of sandwich container 500 as described herein including, but not limited to, thermal sealing strips and/or substantially vapor-tight strips.

Compartment piece 502 includes a plurality of tray support lips 514, wherein lips 514 are at least on the two opposing sides of container 500 and may be extended along each side of container 500.

Sandwich container 500 also includes an adjustable, removable tray 516 that is at least partially supported by at least one set of plurality of tray lips 514. Tray 516, when inserted into compartment piece 502, defines a bread compartment 518 and a sandwich ingredients compartment 520. Bread slices 522 are placed on top of tray 516 within bread compartment 518.

Sandwich container 500 also includes a sealable pouch 524 that is inserted within sandwich ingredients compartment 520, wherein pouch 524 includes a closeable end 526 and an opposite permanently sealed end 527. Pouch 524 is manufactured with a double-wall configuration such that a gel 528 is stored therein. Gel 528 is substantially similar to that found in a commercially-available cold pack and is adapted to maintain a low temperature (i.e., a temperature below a predefined temperature) for an extended period of time after first being refrigerated or frozen. Wet foods are enclosed within sealable pouch 524, wherein pouch 524 receives and chills wet ingredients 530 for making a sandwich. Moreover, gel 528 is adaptable to maintain an elevated temperature (i.e., a temperature above a predefined temperature) after first being heated.

In some embodiments, sandwich container 500 may include a first bread indentation 532 and complementary second bread indentation 534, both defined within compartment piece 502 such that they facilitate placement of bread (not shown in FIG. 13) therein.

In the exemplary embodiment, sandwich container 500 is substantially formed of aluminum. Alternatively, sandwich container 500 is formed of any materials that enable operation of sandwich container 500 as described herein including, but not limited to, durable plastics and/or rubber compounds. Sandwich container 500 may be positioned in a flat position (as shown in FIG. 13) or an upright position (as shown in FIG. 14, discussed below).

FIG. 15 is a side view of an alternative exemplary racked dual compartment sandwich container 600. Container 600 is similar to container 500 (shown in FIG. 14) with the exception that sandwich container 600 includes a compartment piece 602 and a hingedly movable door piece 604 that is hingedly coupled to a side 614. In this alternative embodiment, sandwich container 600 includes a latching device 606, wherein device 606 includes a latch clasp 608 coupled to door piece 604 and a latch groove 610 defined in compartment piece 602. Latch clasp 608 engages latch groove 610 to facilitate closing and sealing sandwich container 600. Container 600 also includes a door hinge mechanism 612 that is hingedly coupled to both compartment piece 602 and door piece 604 at one side 614 of container 600 to facilitate an approximately 180° arcual movement in a plane orthogonal to hinge mechanism 612. Sandwich container 500 may be positioned in a flat position (as shown in FIG. 14) or an upright position (as shown in FIG. 15).

FIG. 16 is an inside perspective view of an exemplary racked dual compartment sandwich container 700. Sandwich container 700 is similar to containers 500 and 600 (shown in FIGS. 14 and 15, respectively), for example, compartment piece 702 is substantially similar to compartment pieces 502 and 602. However, there is an exception that sandwich container 700 includes a compartment piece 702 that defines at least one of a plurality of tray support lips 704 and/or a plurality of tray support channels 706. Sandwich container 700 also includes a removable tray 708 that is at least partially supported by at least one set of plurality of tray support lips 704 and/or plurality of tray support channels 706. Tray 708 is similar to tray 322 (shown in FIGS. 10 and 11) and when inserted into compartment piece 702, defines a bread compartment 710 and a sandwich ingredients compartment 712. Bread slices 522 (shown in FIG. 14) may be placed on top of tray 708. Tray 708 is reversible and, when removed and reversed compartment 712 is reduced in volume and compartment 710 is increased in volume such that compartment 710 may receive a ready-to-eat sandwich (not shown in FIG. 16) on top of tray 708.

Sandwich container 700 also includes sealable pouch 524 that is inserted within sandwich ingredients compartment 712. In other alternative embodiments, there are sufficient tray support lips 704 and/or tray support channels 706 to facilitate reducing a potential for bread 522 to be exposed to condensation by adjusting a height of tray 708.

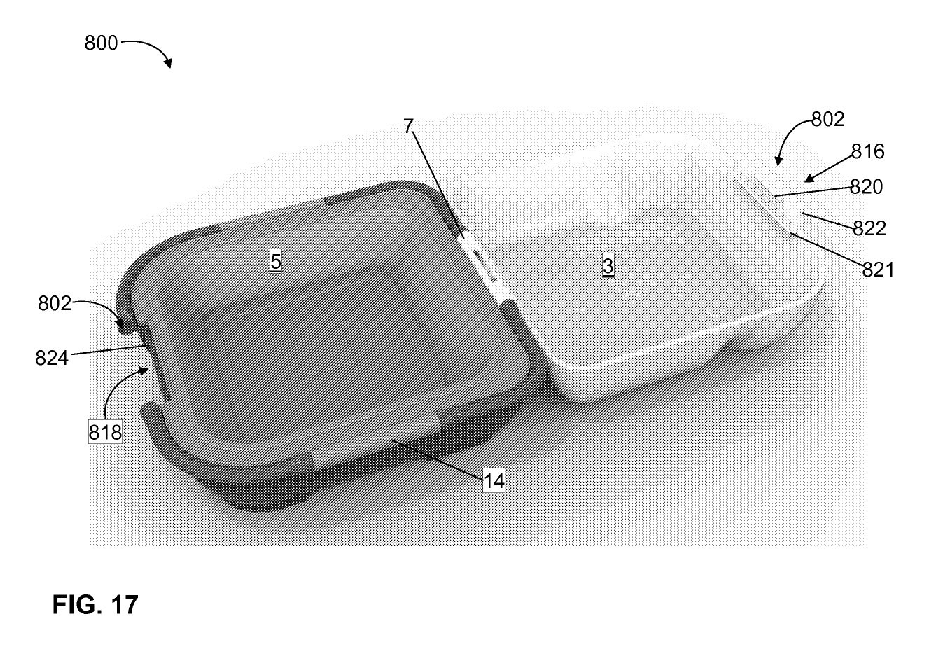

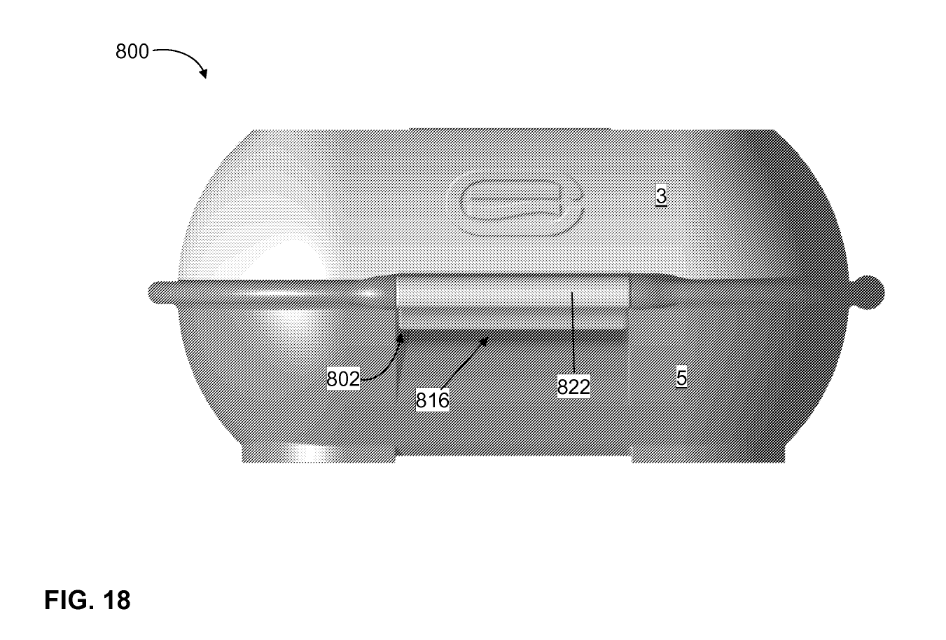

FIG. 17 is a perspective view of a dual compartment sandwich container 800 that is substantially similar to container 1 (shown in FIG. 1) with a first alternative closing mechanism 802. FIG. 18 is a front view of sandwich container 800. First alternative closing mechanism 802 is a hook-latch-type mechanism that includes a locking tang 816 and a complementary locking slot 818 defined by both lower body 5 and adjustable divider 12, wherein locking tang 816, when inserted into locking slot 818, facilitates closing and sealing sandwich container 800. Locking tang 816 includes an upper latching lip 820, a lower latching lip 821, and a finger portion 822. In the exemplary embodiment, upper latching lip 820 and finger portion 822 form a unity piece. Locking slot 818 is at least partially defined by at least one latching surface and/or protrusion 824. Finger portion 822 is configured and oriented to facilitate accommodation of a user's fingers. To close mechanism 802, as upper body 3 is closed over lower body 5 via hinge 7, a user presses on upper body 3 or on locking tang 816 of closing mechanism 802 to engage latching surface/protrusion 824 by engaging upper latching lip 820 therewith. To open mechanism 802, a user simply uses a finger to “pull” on finger portion 822 to disengage from latching surface and/or protrusion 824.

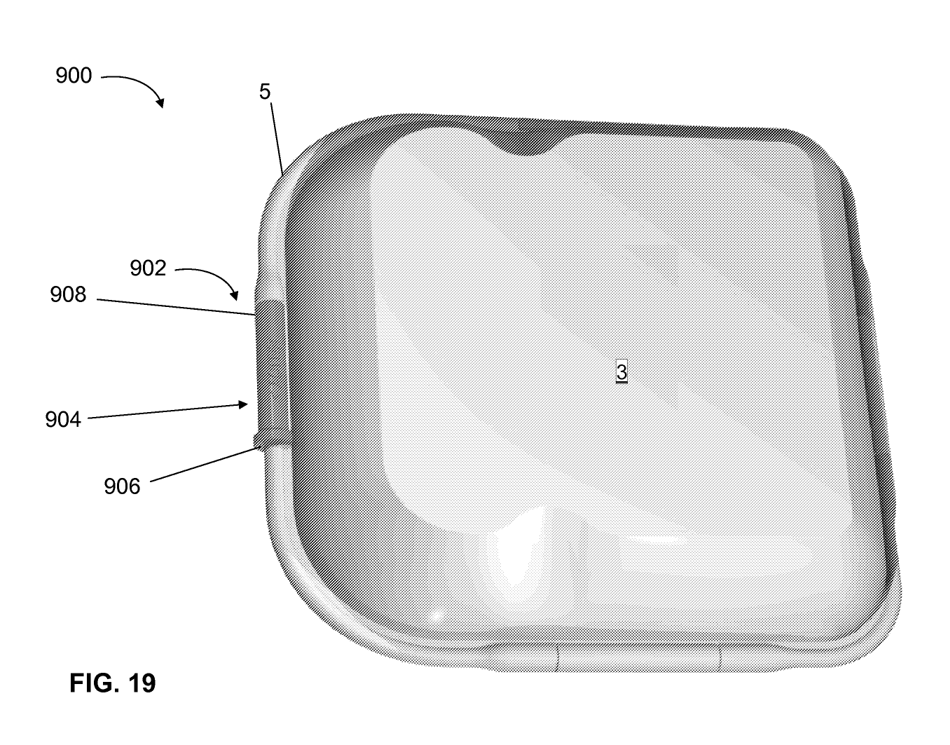

FIG. 19 is a perspective view of dual compartment sandwich container 900 similar to that shown in FIG. 1, but with a second alternative closing mechanism 902. Mechanism 902 is a barrel slide latch mechanism that includes a finger portion, or a finger grip 904 that engages a portion of lower body 5. Finger grip 904 includes a finger protrusion 906 and a barrel portion 908 that are unitarily formed together. Finger grip 904 is configured to slide over a portion of lower body 5, wherein finger grip 904 closes, or clamps thereon. To open container 900, a user pulls on finger grip 904, preferably finger protrusion 906, such that barrel portion 908 pulls away from lower body 5. To close container 900, the user pushes finger grip 904 such that barrel portion 908 slides onto and clamps onto lower body 5.

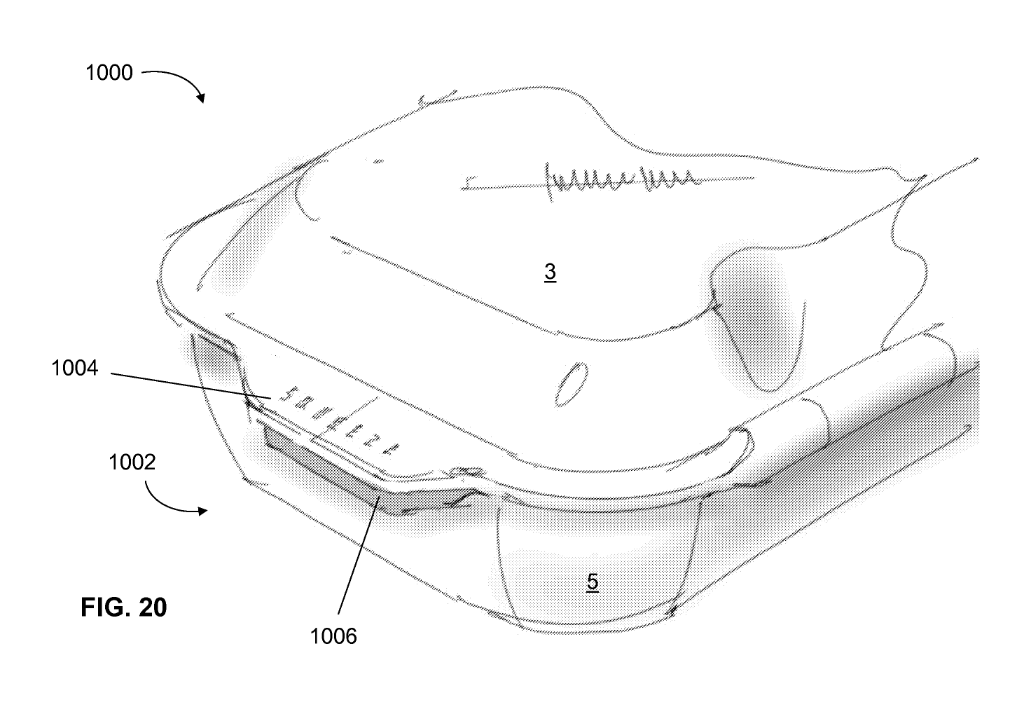

FIG. 20 is a perspective view of a dual compartment sandwich container 1000 that is substantially similar to container 1 (shown in FIG. 1) with a third alternative closing mechanism 1002. Mechanism 1002 is a compression device that includes a stationary upper protruding tab 1004 that is unitarily formed with upper body 3. Mechanism 1002 also includes a squeezable complementary lower compressible portion 1006 that is coupled to or unitarily formed with lower body 5. Portion 1006 is squeezed against/towards tab 1004 to open portion 1002. Portion 1004 is pushed down against lower body 5 to trigger a locking mechanism (not shown) to close container 1000.

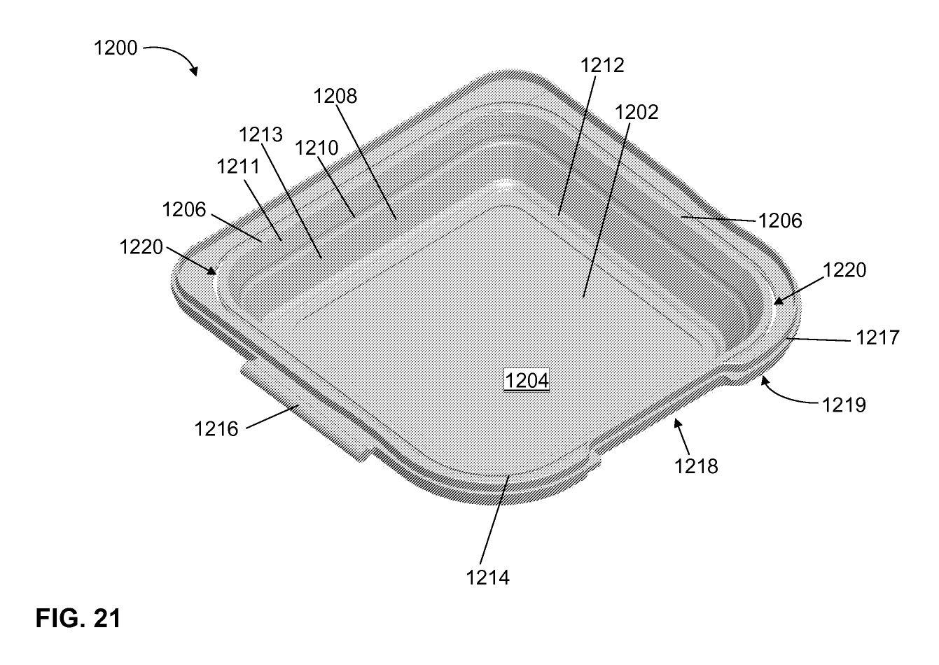

FIG. 21 is a perspective view of an alternative adjustable divider 1200 that may be used with dual compartment sandwich container 1 (shown in FIG. 1). In this exemplary alternative embodiment, divider 1200 includes a transverse member 1202 that is sometimes referred to as the bucket and/or the base. Transverse member 1202 is manufactured from a hard plastic, for example, but without limitation, polypropylene that facilitates resiliency and supportive strength and stability to a surface 1204 of transverse member 1202. Alternatively, transverse member 1202 is manufactured from materials that include, without limitation, TPE, or a similar material. Divider 1200 also includes an inner rim 1206 that defines an inner periphery of divider 1200. Divider 1200 further includes a wall 1208 extending between transverse member 1202 and inner rim 1206. Wall 1208 and inner rim 1206 are formed unitarily and are manufactured from a stiff, hard rubber having a shore value of approximately 60 to 80, for example, but without limitation, TPE, or a similar material. Shore, or shore hardness, is a unitless value that measures a resistance of material to indentation, that is, a stiffness of the material, and the higher the shore value, the greater the resistance to indentation, therefore the greater the stiffness and/or hardness of the material.

Moreover, divider 1200 includes a pair of reversing creases, that is, an upper reversing crease 1210 and a lower reversing crease 1212 that are substantially similar to continuous reversing creases 42 and 44 (shown in FIG. 1). Reversing creases 1210 and 1212 are configured and positioned such that transverse member 1202, inner rim 1206, and wall 1208 can be displaced relative to one another, whereby divider 1200 can be manipulated by the user to either one of a stable upper, or raised cap position/configuration, or a stable lower, or recessed dish position/configuration in response to a pressing force applied to surface 404. Reversing creases 1210 and 1212 are portions of wall 1208 that are made of substantially similar materials as adjoining portions of wall 1208, however, creases 1210 and 1212 are thinner than such adjoining portions, thereby at least partially weakening those portions of divider 1200 defined by creases 1210 and 1212. Therefore, transverse member 1202 is hingedly coupled to wall 1208 by reversing crease 1212 therebetween.

In this exemplary alternative embodiment, each of creases 1210 and 1212 are configured to have a concave/convex shape (from an inward/outward perspective, respectively) with respect to wall 1208, thereby defining a slight bend in wall 1208 in the immediate vicinities of creases 1210 and 1212. Such slight bend and concave shape facilitates inducing a biasing within each of crease 1210 and 1212, thereby facilitating reducing mechanical stresses induced therein and increasing longetivity and durability of creases 1210 and 1212 throughout a multitude of user manipulation between the two aforementioned positions/configurations. Crease 1210 separates wall 1208 into an upper wall 1211 between crease 1210 and inner rim 1206 and a lower wall 1213 between crease 1210 and lower crease 1212.

Divider 1200 also includes an outer rim 1214 that defines an outer periphery of divider 1200, wherein outer rim 1214 includes a lifting latch 1216, similar to lifting lip 30 (shown in FIG. 1), formed unitarily thereon, a latch recess 1218 defined therein, an upper sealing lip 1217 and a lower sealing lip 1219, both sealing lips 1217 and 1219 extending about the outer periphery of divider 1200. Outer rim 1214 is manufactured from a TPE that is a less stiff, more flexible rubber than the TPE used to manufacture wall 1208 and inner rim 1206, wherein the TPE for outer rim 1214 has a shore value of approximately 30 to 40. Divider 1200 further includes a channel 1220 defined between inner rim 1206 and outer rim 1214 that is sized to receive a plurality of stiffening rings (not shown in FIG. 21), discussed further below.

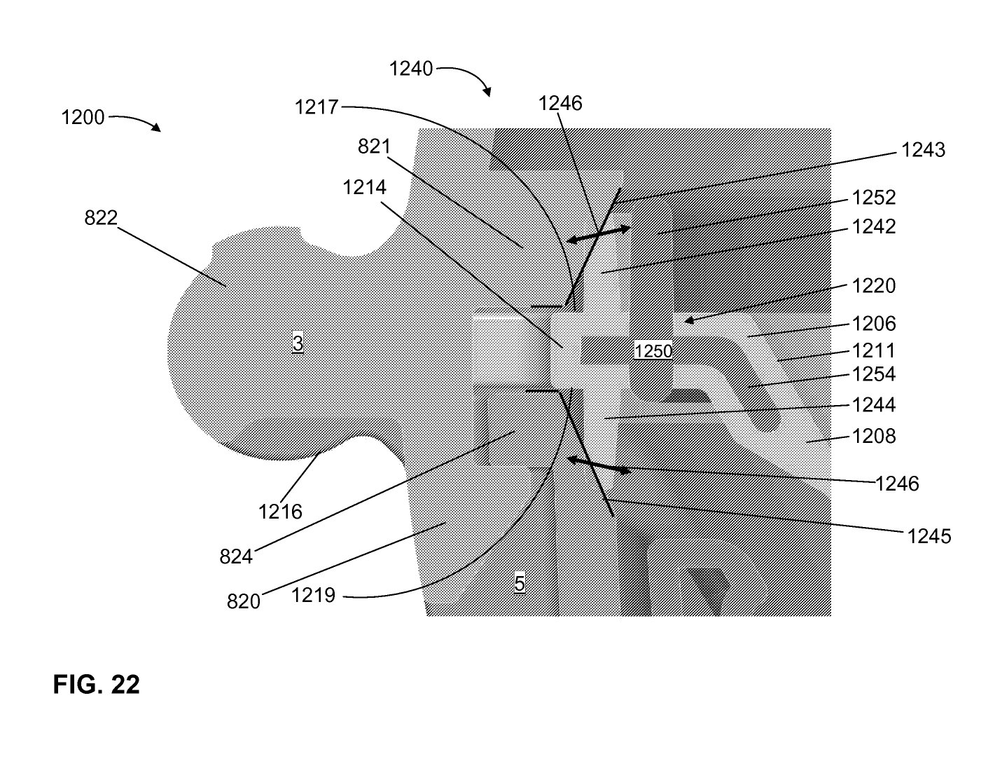

FIG. 22 is a schematic cross-sectional side view of a wiping sealing mechanism 1240 that may be used with adjustable divider 1200. In this alternative exemplary embodiment, seal mechanism 1240 includes portions of inner rim 1206 and outer rim 1214. Specifically, seal mechanism 1240 includes an upper wiping rib 1242 and a lower wiping rib 1244, both manufactured unitarily with outer rim 1214 with TPE having a lesser shore value of approximately 30 to 40. Also, specifically, seal mechanism 1240 includes a portion of upper body 3, that is, an upper body sealing surface 1243. Further, specifically, sealing mechanism 1240 includes a portion of lower body 5, that is, a lower body sealing surface 1245. Moreover, specifically, sealing mechanism 1240 includes divider upper sealing 1217 and divider lower sealing lip 1219.

Both wiping ribs 1242 and 1244 have sufficient flexibility to bend inward as shown by bi-directional arrows 1246 when upper body 3 is lowered towards lower body 5, wherein both bodies 3 and 5 are manufactured from a plastic material including, without limitation, polypropylene. Moreover, both wiping ribs 1242 and 1244 have sufficient flexibility to bend outward to return to their original positions when upper body 3 is raised away from lower body 5 as also shown by bi-directional arrows 1246.

Sealing mechanism 1240 also includes a reinforcing device, or stiffening ring device 1250 that includes an upright ring section 1252 and a unitarily-formed lateral ring section 1254. Stiffening ring device 1250 is manufactured from a plastic material including, without limitation, polypropylene, and facilitates circumferential support and stiffness. Stiffening ring device 1250 extends about the entire inner and outer peripheries defined by inner rim 1206 and outer rim 1214, respectively. Therefore, during an inward flex of wiping rib 1242, it wipes, that is, it slides and depresses against upper body sealing surface 1243, thereby forming an upper seal. Moreover, during an inward flex of wiping rib 1244, it wipes, that is, slides and flexes against lower body sealing surface 1245, thereby forming a lower seal. Move over, the upper seal is at least partially formed when upper body sealing surface 1243 contacts divider upper sealing lip 1217 and the lower seal is at least partially formed when lower body sealing surface 1245 contacts divider lower sealing lip 1219.

Modulating the stiffness values of TPE used in portions of sealing mechanism 1240 facilitates sealing of the sandwich container and shifting between two, or more, positions/configurations. One method of modulating such stiffness includes injection molding techniques, such as overmolding, during fabrication of portions of sealing mechanism 1240. Overmolding of a hard material, such as polypropylene, with a more stiff TPE facilitates wall 1208 retaining its raised cap position/configuration while facilitating greater durability between configuration changes. An additional overmold of another, less stiff TPE material, facilitates a more flexible seal contact area along outer rim 1214, divider upper sealing lip 1217, divider lower sealing lip 1219, upper wiping rib 1242, and lower wiping rib 1244. Such sealing mechanism is referred to as a triple-shot sealing mechanism used to describe use of a hard plastic, a stiff TPE rubber, and a less stiff TPE rubber therein.

In addition to functioning as a flexible divider for division of internal compartments 10 and 11, divider 1200 also provides seal features between internal compartments 10 and 11 of sandwich container 1. Specifically, in addition to functioning as a multi-position divider, divider 1200 may further include two flexible materials of differing hardness/stiffness values such that one of the flexible membrane materials has a higher hardness/stiffness value that is optimized for the function of divider 1200 as a multi-position compartment divider and the other flexible material has a softer hardness/stiffness value that is optimized for providing a sealing feature, for example, sealing mechanisms 1200 and 1240, between divider 1200 and outer housing 4 of sandwich container 1.

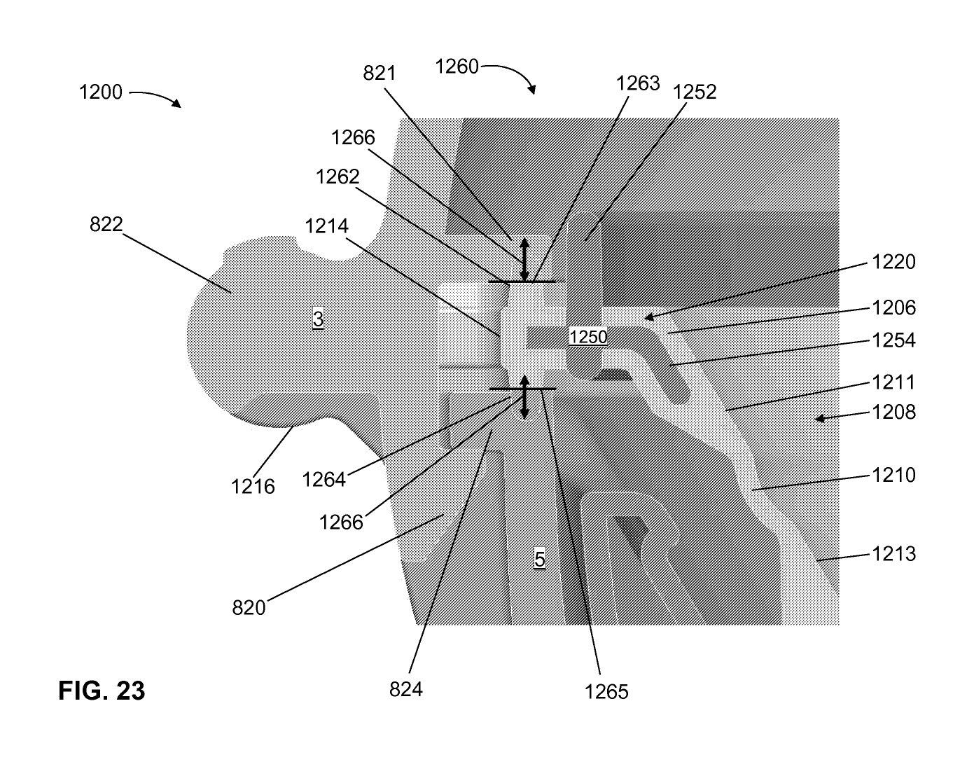

FIG. 23 is a schematic cross-sectional side view of a compression sealing mechanism 1260 that may be used with adjustable divider 1200. In this alternative exemplary embodiment, seal mechanism 1260 includes portions of inner rim 1206 and outer rim 1214. Specifically, seal mechanism 1260 includes an upper compression rib 1262 and a lower compression rib 1264, both manufactured unitarily with outer rim 1214 with TPE having a lesser shore value of approximately 30 to 40. Also, specifically, seal mechanism 1260 includes a portion of upper body 3, that is, an upper body sealing surface 1263. Further, specifically, sealing mechanism 1260 includes a portion of lower body 5, that is, a lower body sealing surface 1265.

Both wiping ribs 1262 and 1264 have sufficient flexibility to bend upward and downward, respectively, as shown by bi-directional arrows 1266 when upper body 3 is lowered towards lower body 5, wherein both bodies 3 and 5 are manufactured from a plastic material including, without limitation, polypropylene. Moreover, both compression ribs 1262 and 1264 have sufficient flexibility to return to their original positions when upper body 3 is raised away from lower body 5 as also shown by bi-directional arrows 1266.

Sealing mechanism 1260 also includes stiffening ring device 1250 that includes upright ring section 1252 and unitarily-formed lateral ring section 1254, wherein device 1250 facilitates circumferential support and stiffness. Stiffening ring device 1250 extends about the entire inner and outer peripheries defined by inner rim 1206 and outer rim 1214, respectively. Therefore, during an inward press of rib 1262, it compresses against upper body sealing surface 1263, thereby forming an upper seal. Moreover, during an inward press of rib 1264, it compresses against lower body sealing surface 1265, thereby forming a lower seal.

In a manner substantially similar to sealing mechanism 1240 (shown in FIG. 23), sealing mechanism 1260 is referred to as a triple-shot sealing mechanism used to describe use of a hard plastic, a stiff TPE rubber, and a less stiff TPE rubber therein.

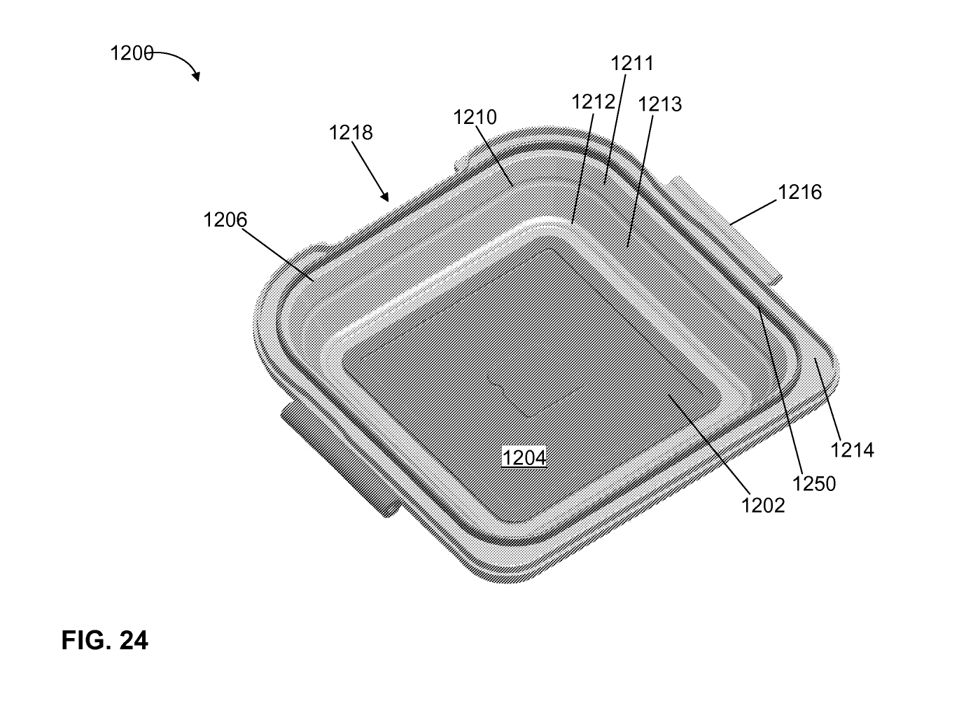

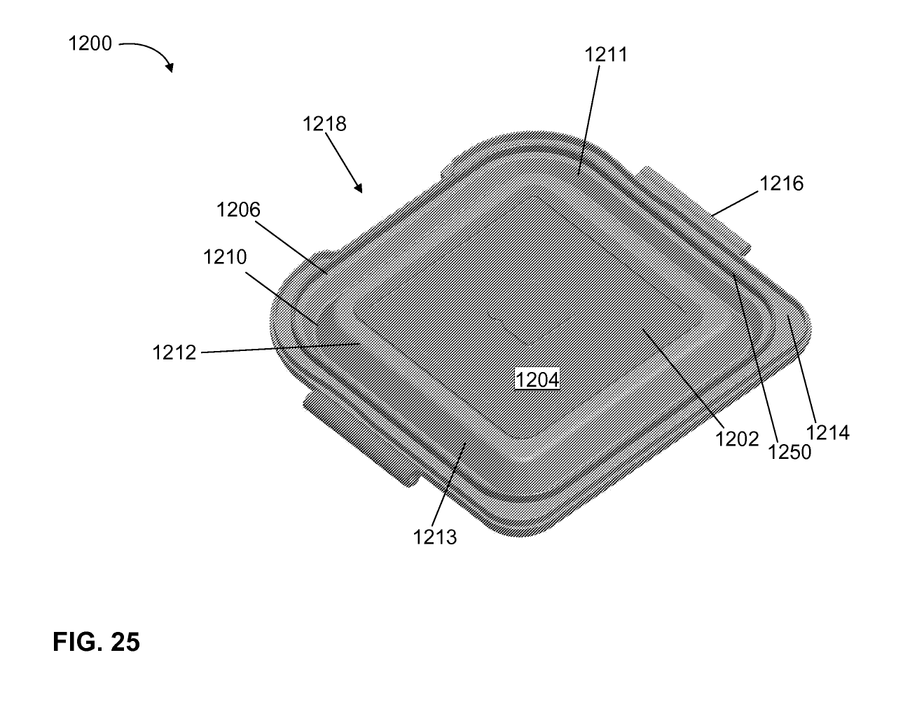

FIG. 24 is a schematic cross-sectional side view of adjustable divider shown 1200 in a lower/recessed stable position. FIG. 25 is a schematic cross-sectional side view of adjustable divider 1200 in an upper/raised stable position. To change the position/configuration of divider 1200 from recessed to raised, a user depresses the bottom of transverse member 1202 with sufficient induced force to overcome the biasing induced by creases 1210 and 1212. Once the threshold bias value is exceeded by the user, lower crease 1212 will reverse from a concave configuration with respect to wall 1208 to a convex configuration. Also, surface 1204 of transverse member 1202 will raise with respect to inner and outer rims 1206 and 1214, respectively. Further, crease 1210 will retain a concave configuration with respect to wall 1208, however, crease 1210 will shift its concavity by approximately 90 degrees as upper wall 1211 remains stationary and lower wall 1213 shifts from a configuration facing inward towards transverse member 1202 to a configuration facing outward from transverse member 1202. In the lower/recessed stable position, transverse member 1202 is sometimes referred to as the basket and/or the base, wherein transverse member 1202 is configured to receive materials that include, without limitation, a whole sandwich or wet sandwich materials. In the upper/raised stable position, transverse member 1202 is sometimes referred to as the platform, wherein transverse member 1202 is configured to receive materials on surface 1204 that include, without limitation, sandwich bread slices.

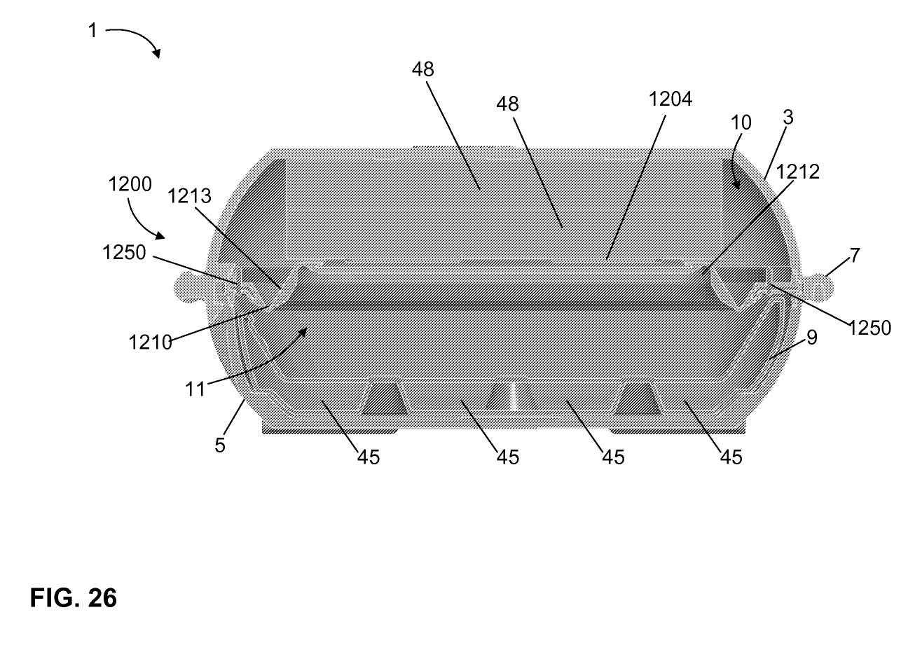

FIG. 26 is a schematic cross-sectional side view of dual compartment sandwich container 1 with alternative adjustable divider 1200 in the upper/raised stable position as shown in FIG. 18 with removable tray 9 therein, that is, removable tray 9 is removably received within lower compartment 11. Tray 9 is filled with thermal gel 45, such thermal gel 45 being substantially similar to that found in a commercially-available cold pack and is adapted to maintain a low temperature (i.e., a temperature below a predefined temperature) for an extended period of time after first being refrigerated or frozen. Therefore, tray 9 and thermal gel 45 within may be refrigerated or frozen to create a cold pack, and tray 9 is recessed so as to receive and chill wet ingredients 530 (shown in FIG. 14) for making a sandwich. Moreover, thermal gel 45 is adapted to maintain an elevated temperature (i.e., a temperature above a predefined temperature) after first being heated. Therefore, thermal gel 45 inside removable tray 9 facilitates maintaining sandwich ingredients 46 approximately at a desired temperature to reduce a potential for spoilage when the sandwich will not be immediately consumed.

Moreover, a plurality of dry slices of sandwich bread 48 are located in upper compartment 10 on top of surface 1204, and divider 1200 is rotated to its seated position over tray 9 to segregate dry bread 48 from wet ingredients 46. In order to accommodate tray 9 and sandwich ingredients 46 within lower compartment 11, an upward pushing force is applied to transverse member 1202 of divider 1200 to cause divider 1200 to assume its raised stable configuration as described above.

In this exemplary alternative embodiment, adjustable divider 1200 divides upper compartment 10, and materials stored therein, from lower compartment 11, and the materials stored therein. Also, divider 1200 provides a transverse member 1202 that is flexible enough to allow overfilling of lower compartment 11, while rigid enough to support materials on either side of transverse member 1202. Such flexibility and rigidity is modulated as a function of the intended commercial use of divider 1200. Moreover, divider 1200 transitions between two stable configurations, this is, a raised position and a lowered position. Rigid components of divider 1200 are manufactured such that a flexible membrane is bonded/overmolded to divider 1200 by chemical and/or mechanical bonding processes, such that during manufacturing of divider 1200 the flexible membrane and rigid components combine to facilitate assembly of the two materials to form to a higher-level product assembly, that is, outer housing 4 (shown in FIG. 1) of sandwich container 1.

In addition to functioning as a flexible divider for division of internal compartment, divider 1200 also provides seal features between internal compartments of sandwich container 1. Specifically, in addition to functioning as a multi-position divider, divider 1200 may further include two flexible materials of differing hardness/stiffness values such that one of the flexible membrane materials has a higher hardness/stiffness value that is optimized for the function of divider 1200 as a multi-position compartment divider and the other flexible material has a softer hardness/stiffness value that is optimized for providing a sealing feature, for example, sealing mechanisms 1240 and 1260, between divider 1200 and outer housing 4 of sandwich container 1.

The sandwich containers described herein, and the methods of assembling such sandwich containers, facilitate storage and transport of sandwiches and sandwich materials. Specifically, the sandwich containers are assembled to maintain a freshness and/or a temperature of a completed sandwich, or the ingredients therein. Also, specifically, the sandwich containers are assembled to maintain the bread in a dry state. More specifically, the sandwich containers described herein provide sufficient internal storage space to either separate the bread slices from the wet ingredients and/or a mechanism to keep an entire assembled sandwich and its ingredients cool and fresh. Further, specifically, the sandwich containers are assembled to protect the sandwich and/or sandwich ingredients from crushing during transport and storage. Therefore, the sandwich storage containers described herein have sufficient strength to reduce a potential for damage to the sandwich and to withstand repeated use, including repeated washings. Moreover, the sandwich containers described herein include components that facilitate ease of converting the sandwich containers from storage for sandwich components to storage for ready-to-eat sandwiches with only minor adjustments of the configuration of the sandwich containers. Furthermore, the sandwich containers described herein facilitate ease of cleaning after each use and then are to be reused so as to reduce waste.

Exemplary embodiments of sandwich containers are described above in detail. The methods, apparatus and systems are not limited to the specific embodiments described herein nor to the specific illustrated sandwich containers.

While the invention has been described in terms of various specific embodiments, those skilled in the art will recognize that the invention can be practiced with modification within the spirit and scope of the claims.

What is claimed is:

1. A flexible divider for separating a lower compartment of a container from an upper compartment of the container, said divider comprising:
a transverse member;
a rim defining an outer perimeter of said divider; and
a flexible wall connecting said transverse member to said rim, said flexible wall configured to facilitate movement of said transverse member from an upper stable position to a lower stable position.

2. A flexible divider in accordance with claim 1, wherein the upper stable position of said transverse member is above said rim.

3. A flexible divider in accordance with claim 1, wherein the lower stable position of said transverse member is below said rim.

4. A flexible divider in accordance with claim 1, wherein said rim comprises an inner rim and an outer rim, wherein said inner rim and said outer rim at least partially define a sealing mechanism therebetween.

5. A flexible divider in accordance with claim 4, wherein said sealing mechanism comprises:
an upper seal comprising a lid body sealing surface, an upper sealing lip, an upper sealing rib, and a reinforcing member, wherein said upper seal is formed by contact of said lid body sealing surface with said upper sealing lip and said upper sealing rib; and
a lower seal comprising a tray body sealing surface, a lower sealing lip, and a lower sealing rib, wherein said lower seal is formed by contact of said tray body sealing surface with said lower sealing lip and said lower sealing rib.

6. A flexible divider in accordance with claim 5, wherein said inner rim comprises a first material having a first stiffness value, wherein said upper sealing rib and said lower sealing rib comprise a second material having a second stiffness value, wherein the first stiffness value is greater than the second stiffness value.

7. A flexible divider in accordance with claim 6, wherein said sealing mechanism comprises one of a wiping sealing mechanism and a compression sealing mechanism.

8. A flexible divider in accordance with claim 1, wherein said flexible wall comprises at least one reversing crease extending around at least one of an outer perimeter and an inner perimeter of said divider rim.

9. A flexible divider in accordance with claim 8, wherein said flexible wall comprises:
an upper wall portion;
a lower wall portion;
an upper reversing crease extending between said upper wall portion and said lower wall portion; and
a lower reversing crease extending between said lower wall portion and said transverse member, said upper reversing crease and said lower reversing crease configured to facilitate movement between the upper stable position and the lower stable position of said transverse member.

10. A sandwich container comprising an outer housing defining a first compartment and a second compartment, said sandwich container comprising a divider separating said first and second compartments, said divider reconfigurable for altering a volume of each of said first and second compartments.

11. A sandwich container in accordance with claim 10, wherein said divider comprises a removable tray comprising at least one of:
a tray hingedly coupled to a tray lid, said tray and tray lid configured to be received within at least one of said first compartment and said second compartment;
a tray having a top rim coupled to a tray lid having a bottom rim, said top rim and said lower rim configured to be received within a support channel defined within at least one of said first compartment and said second compartment; and
a tray configured to be received within a support channel defined within at least one of said first compartment and said second compartment.

12. A sandwich container in accordance with claim 10, wherein said divider comprises:
a transverse member;
a rim defining an outer perimeter of said divider; and
a flexible wall connecting said transverse member to said rim, said flexible wall configured to facilitate movement of said transverse member from an upper stable position to a lower stable position.

13. A sandwich container in accordance with claim 10 further comprising a hinge mechanism comprising a hinge post defining a plurality of slots configured to receive a tray.

14. A sandwich container in accordance with claim 10, wherein at least one of said first compartment and said second compartment is configured to:
receive a sealable pouch; and
receive a gel pack.

15. A sandwich container in accordance with claim 10, wherein said outer housing comprises a first compartment and a second compartment, wherein said first compartment is coupled to said second compartment via an attachment mechanism comprising at least one of:
a tongue and groove sealing mechanism;
a plurality of pushbutton mechanisms;
a latching device comprising a latch clasp and a latch groove;
a sealing mechanism;
a hingedly movable door piece comprising a door hinge mechanism; and
a hingedly movable door piece comprising a latch clasp and a latch groove.

16. A method of assembling a sandwich container, said method comprising:
hingedly coupling an upper body to a lower body, wherein the upper body defines an upper compartment and the lower body defines a lower compartment; and
positioning a flexible divider within the sandwich container, thereby separating the upper and lower compartments, wherein the flexible container includes:
a transverse member;
a rim defining an outer perimeter of the divider; and
a flexible wall connecting said transverse member to the rim, the flexible wall configured to facilitate movement of the transverse member from an upper stable position to a lower stable position.

17. A method in accordance with claim 16 further comprising coupling a sealing mechanism within at least a portion of each of the upper body and the lower body.

18. A method in accordance with claim 17, wherein coupling a sealing mechanism to at least a portion of each of the upper body and the lower body comprises:
forming an upper seal comprising contacting an upper body sealing surface with an upper sealing lip and an upper sealing rib; and
forming a lower seal comprising contacting a lower body sealing surface with a lower sealing lip and a lower sealing rib.

19. A method in accordance with claim 18, wherein coupling a sealing mechanism to at least a portion of each of the upper body and the lower body comprises:
forming the rim of the divider with a first material having a first stiffness value; and
forming the upper sealing rib and the lower sealing rib with a second material having a second stiffness value, wherein the first stiffness value is greater than the second stiffness value.

20. A method in accordance with claim 16, wherein positioning a flexible divider within the sandwich container comprises forming the flexible wall with a first reversing crease extending around an outer perimeter of the transverse member and a second reversing crease extending around an inner perimeter of the divider rim.
